(19) United States
(12) Patent Application Publication
(10) Pub. No.: US 2005/0120180 A1
(43) Pub. Date: Jun. 2, 2005

(54) Cache time determination

(76) Inventors: Stephan Schornbach, Jena (DE); Frank Gessner, Jena (DE); Ulrike Muller, Jena (DE); Christian Malloia, San Francisco, CA (US); Marcus Nawotny, Berlin (DE); Daniel Doubleday, Berlin (DE); Roland Fassauer, Hamburg (DE); Roy Senanch, Jena (DE)

Correspondence Address: Richard A Nebb;Dergosits & Noah, Suite 1450, Four Embarcadero Center, San Francisco, CA, 94111, US

(21) Appl. No.: 10/381,109

(22) PCT Filed: Mar. 30, 2001
(86) PCT No.: PCT/EP01/03679

(30) Foreign Application Priority Data
Mar. 30, 2000 (EP) 001068279

(51) Int. Cl. G06F 12/00

(52) U.S. Cl. 711/133

(57) ABSTRACT

A data storage method comprises the steps of selecting a data set from a data base (104), assigning the selected data set a cache time attribute defining a cache storage period, and storing the data set in a cache memory (106) for a time period defined by said cache time attribute. A storage time period in the cache memory can so be assigned individually to every data set depending on parameters as the data volume of the data set, the access frequency, etc. independently of an output medium as e.g. an HTML.

The present invention relates to a method, apparatus and computer program for temporarily storing data from a data base in a cache memory.

A computer system designed for processing online transactions like e-commerce applications over the internet or a similar data network usually comprises a web server which is accessible through a data transmission medium like the internet by a plurality of clients e.g. personal computers, mobile phones or internet TV sets, an application server connected to the web server for carrying out transactions and a data base or file server or a similar organized storage device connected to the application server for holding the necessary data.

For online transaction applications designed for the mass market the load balancing of the hardware resources is vital for offering reliable services to the customer. It is therefore known to additionally provide a cache memory for storing data which are frequently accessed by clients in order to reduce the number of data base access operations. Preferably the cache memory is accessible by the web server. If a client requests some information from the server, the latter checks whether or not the requested data are contained in the cache memory. If this is the case, the web server directly retrieves the data from the cache memory. Since the data access time of the cache memory is shorter than that of the data base and the processing operations of the application server are not required, the transaction can be carried out faster and the load of the application server can be reduced accordingly. The data retrieved from the cache memory are then formatted and outputted to the client by the web server.

The data stored in the cache memory are stored in the form of the output document (medium) prepared for transfer to the client. The time period for which an output document remains in the cache memory is normally determined by a first-in-first-out mode, that is the “oldest” output document in the cache memory is overwritten by the latest document if the cache memory is full. It is also possible to update the whole content of the cache memory in regular intervals or to define fixed storage times after the latest access, e.g. 1 day or 1 week.

The load of a computer system accessing a data base depends on the data volume of an accessed item and the number of access operations, and/or the CPU load to process the data. With the above described methods of storing output data in a cache memory these factors cannot sufficiently be taken into account.

It is therefore an object of the present invention to avoid the problems present with the known cache storage methods and to improve and optimize the load balancing of the application server accessing the data base.

According to the present invention a data storage method is provided comprising the steps of: selecting a data set from a data base, assigning the selected data set a cache time attribute defining a cache storage period, and storing the data set in a cache memory for a time period defined by said cache time attribute.

According to the invention it is possible to define the storage period of every data set independent of the output medium. It is therefore possible to make the storage time period dependent on suitable parameters, like e.g. on the data quantity of a data set; that is to provide a longer cache period for a larger data set than for a smaller data set since the time and processing resources saved by accessing the cache memory instead of the data base is longer than in the case of a small data set. In addition, the storage period may be adapted to the access frequency of each data set individually. With the present invention it is therefore possible to optimize the load balancing of the application server carrying out the data storage operations. A computer system to which the present invention is applied can thus provide more reliable online transaction services for the customer.

The cache time attribute may be user-defined or defined automatically dependent on computer system parameters like the data quantity of a data set, the access frequency or the current or average load of the computer system or the application server.

The cache time may be defined as a fixed value dependent on a data update cycle of the data base. The cache time may be determined individually for every data set or for specific data set categories. If the cache time is determined for a specific category, the caching time is valid for all data sets which belong to the respective category.

Every data set may be stored separately in the cache memory as a formatted data set. The data sets can be arranged in an output document or template for output to the user.

Alternatively, a plurality of data sets may be stored in the cache memory as part of an output document. The cache time of the output document is preferably determined by the cache time of the data sets contained in the output document. The shortest cache time, the longest cache time or an (arithmetic or geometric) average time of the data set cache times may be selected as the cache time of the output medium. Alternatively, it is also possible to assign different priorities to the data sets. Then, the cache time of the data set having the highest priority is selected as the cache time of the output document.

The output document or output template may be encoded in HTML, XML, WML or any other suitable format for visualization at the client side or for other applications.

The present invention further provides a load management method for a computer system comprising a web server accessible by a plurality of clients through a data transmission medium, an application server, a data base and a cache memory. The method comprises the steps of selecting from the data base a plurality of data sets, assigning selected data sets a cache time attribute defining a cache storage period depending on detected computer system parameters, and storing the data sets in the cache memory for a time period defined by said cache time attribute.

The present invention further provides a computer program and computer program product stored on a storage medium comprising program code adapted to perform the method steps of selecting a data set from a data base, assigning the selected data set a cache time attribute defining a cache storage period and storing the data set in a cache memory for a time period defined by said cache time attribute. The cache time is preferably defined dependent on computer system information.

The present invention still further provides a data structure comprising a plurality of individual data sets to which a cache time attribute is assigned defining a cache storage period in a cache memory.

The present invention still further provides an application server as defined in claim 26 and a computer system as defined in claim 27. Dependent claims 28 to 38 describe further preferred embodiments of the present invention.

The invention and further objects, features and advantages thereof will be more clearly understood from the following description of preferred embodiments thereof and the corresponding drawings, in which:

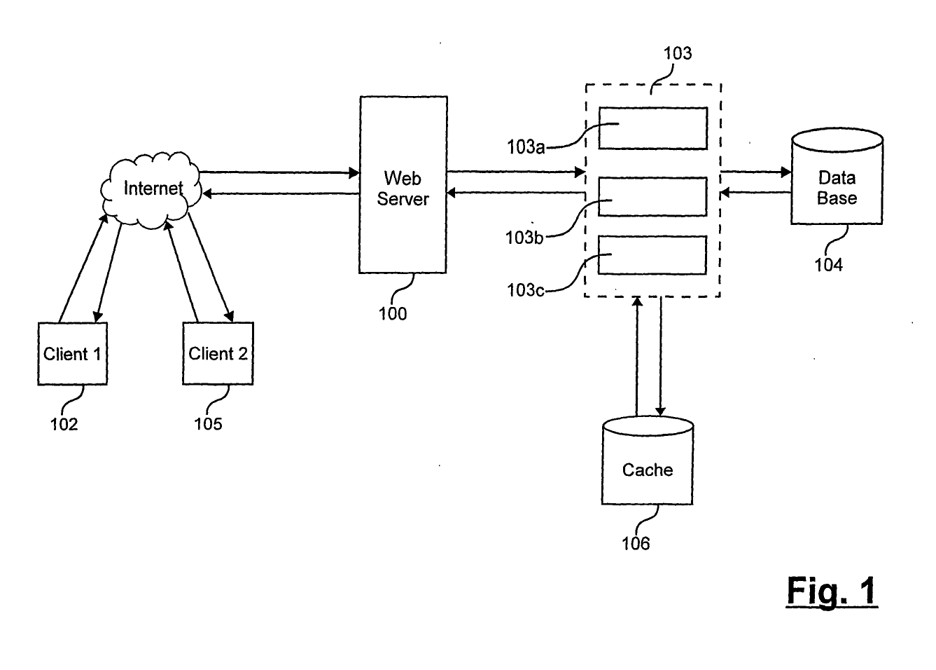

FIG. 1 shows a block diagram of a computer system according to a preferred embodiment of the present invention.

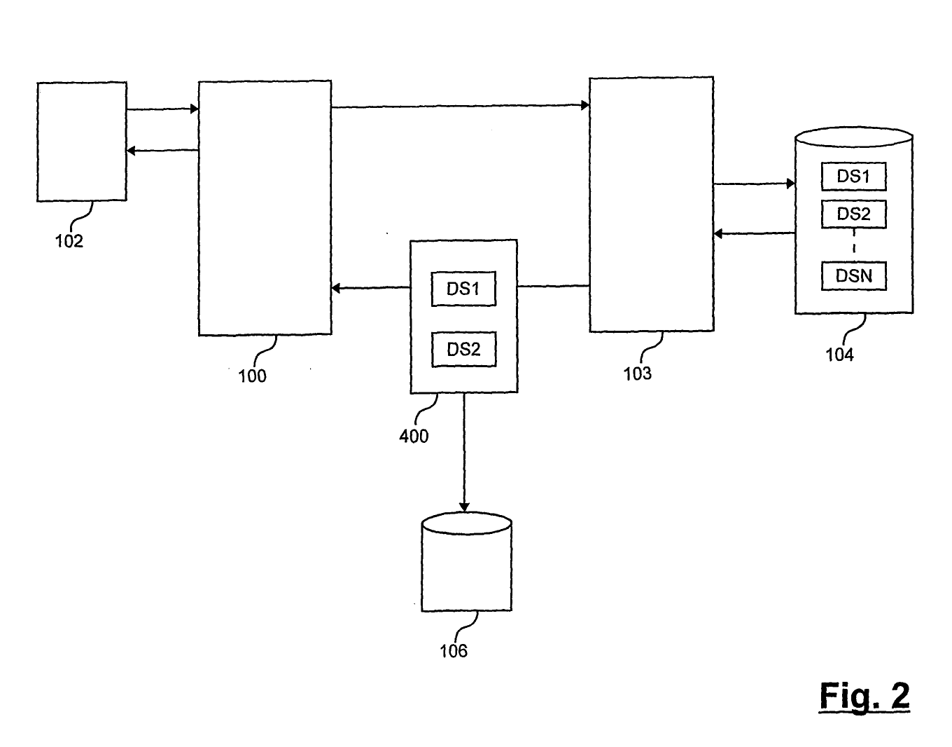

FIG. 2 shows a block diagram of a computer system schematically illustrating the operation of a first embodiment of the present invention.

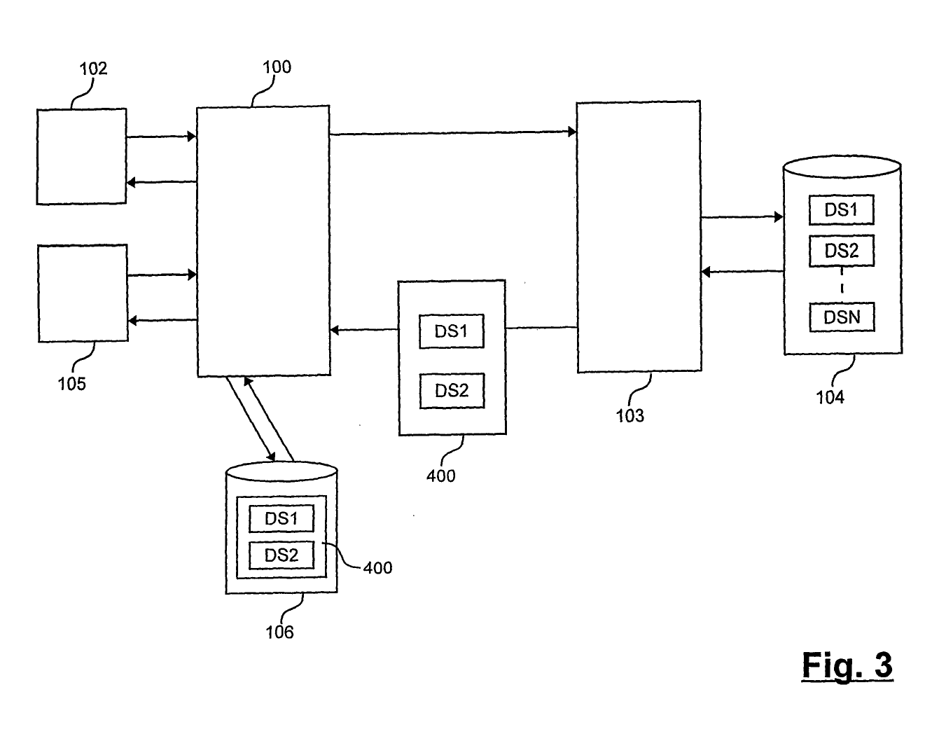

FIG. 3 shows a further block diagram of the computer system schematically illustrating the operation of the first embodiment of the present invention.

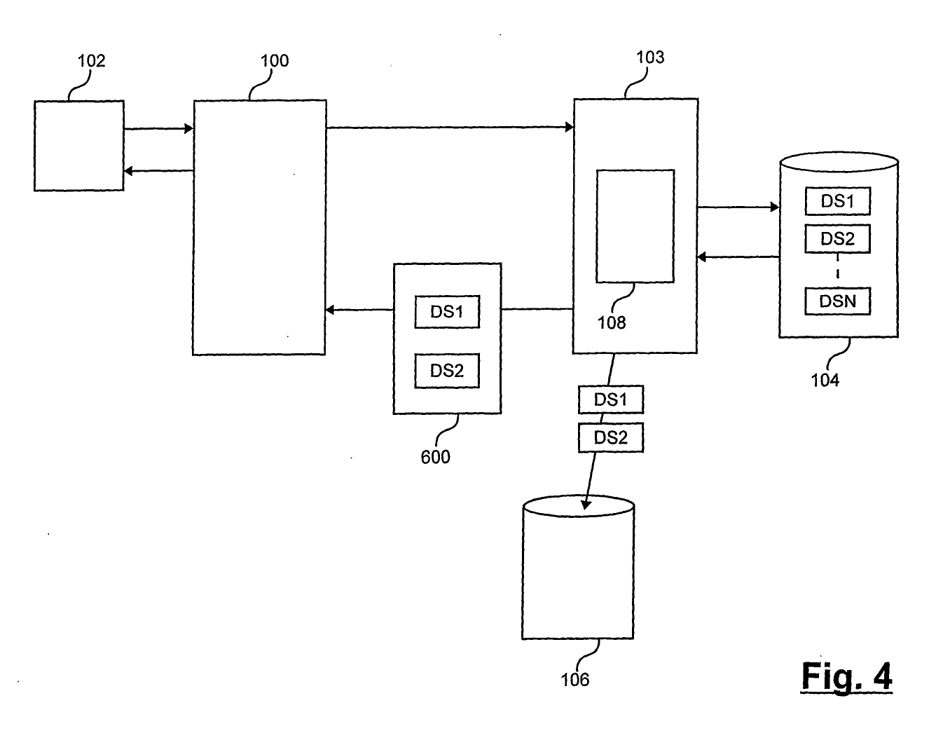

FIG. 4 shows a block diagram of a computer system schematically illustrating the operation of a second embodiment of the present invention.

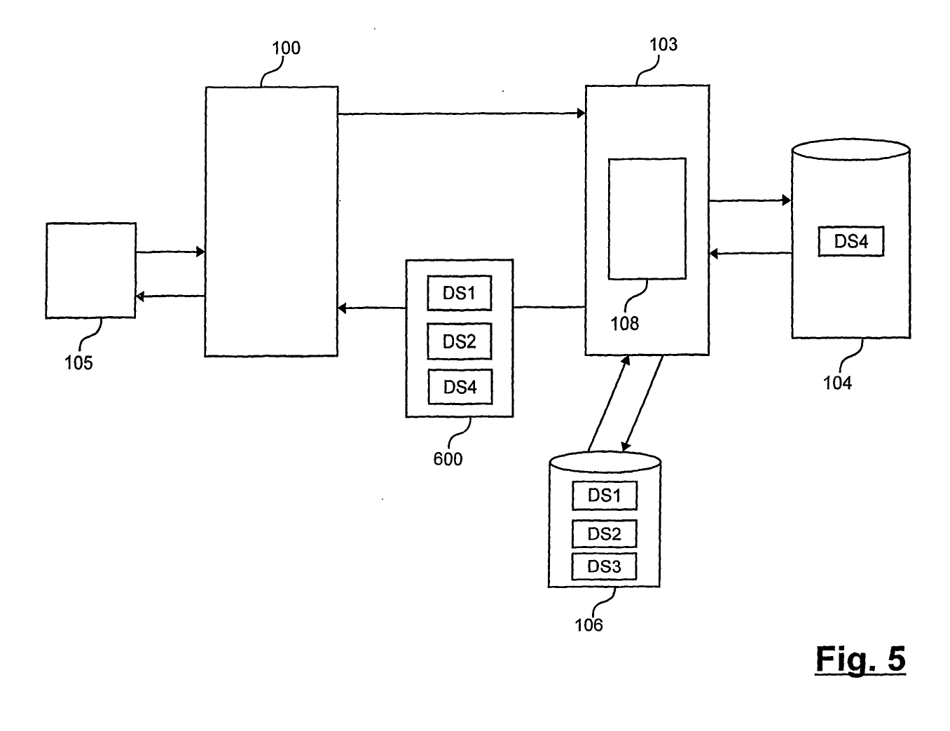

FIG. 5 shows a further block diagram of the computer system schematically illustrating the second embodiment of the present invention.

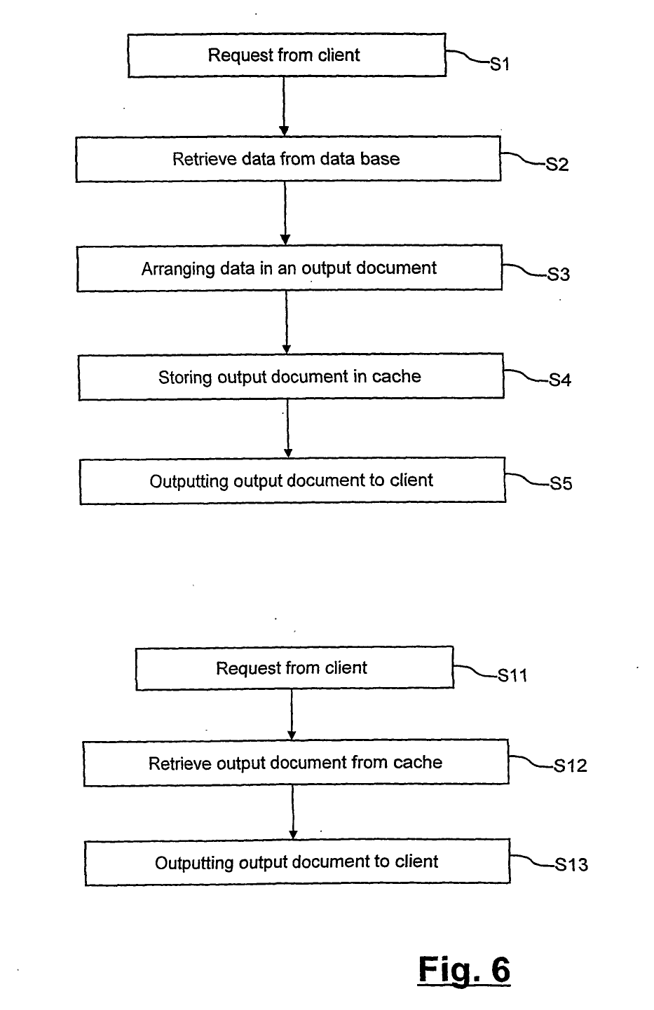

FIG. 6 shows a flow chart illustrating method steps according to the invention for temporarily storing data in a cache memory.

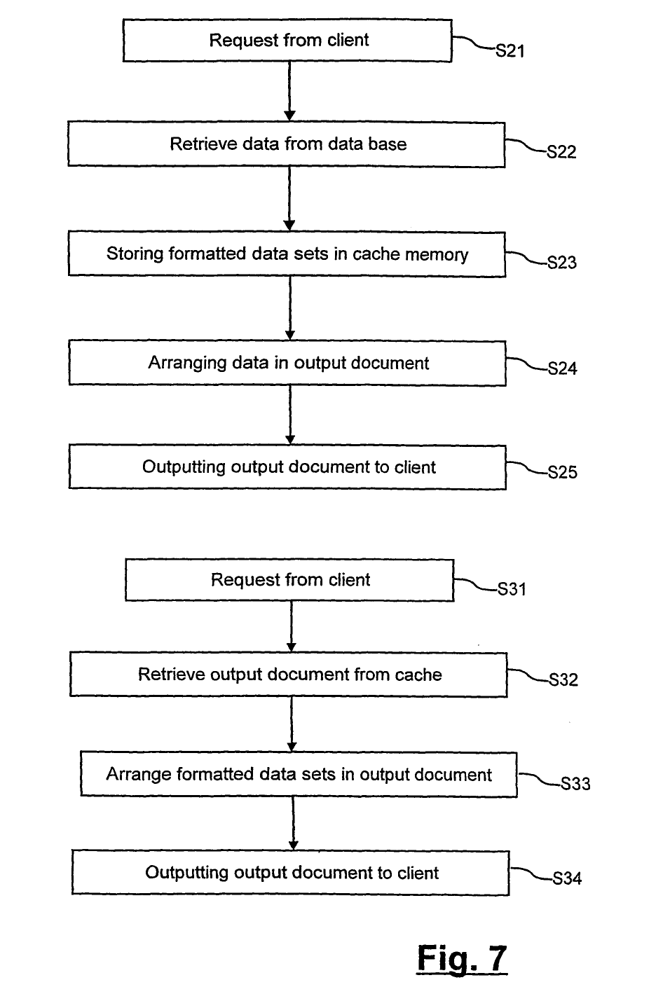

FIG. 7 is a flow chart illustrating method steps according to the invention for storing an output document in a cache memory.

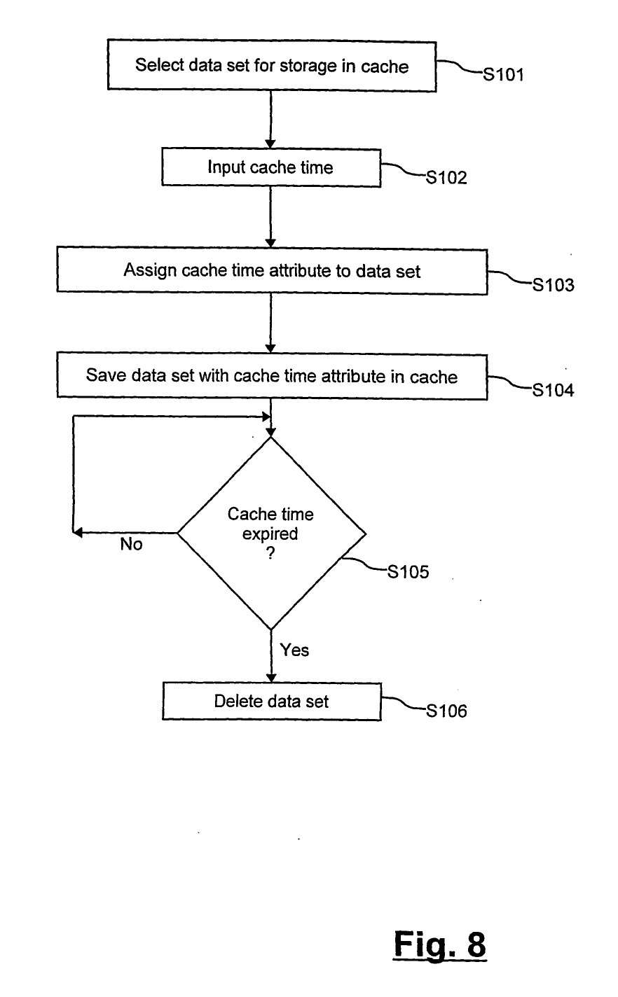

FIG. 8 is a flow chart illustrating method steps of an embodiment of the data storage method according to the present invention.

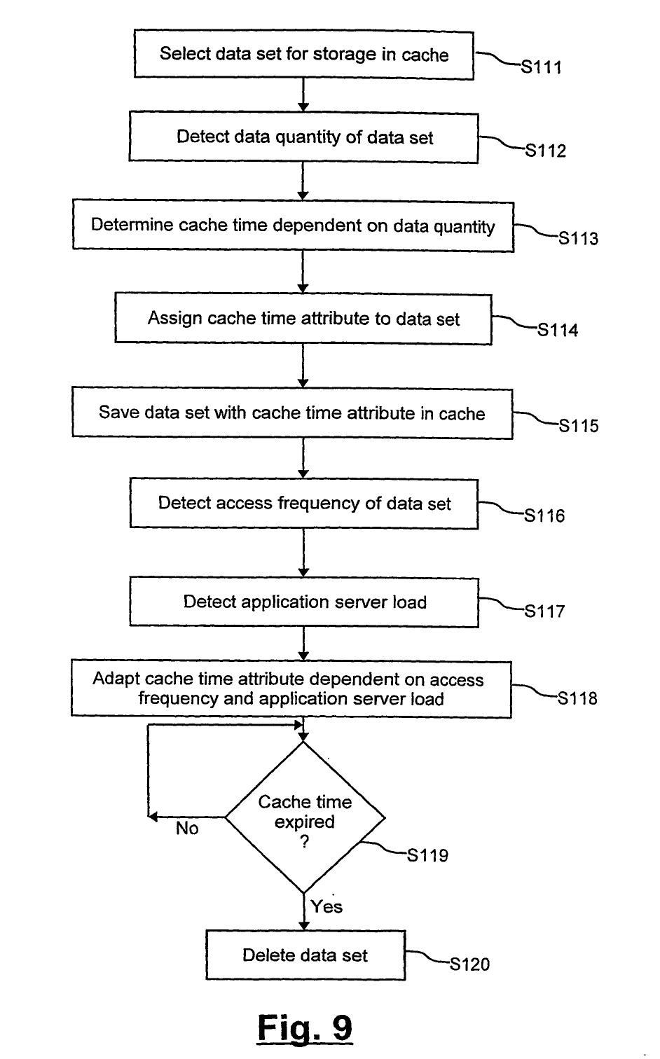

FIG. 9 is a flow chart illustrating method steps of a further embodiment of the data storage method according to the present invention.

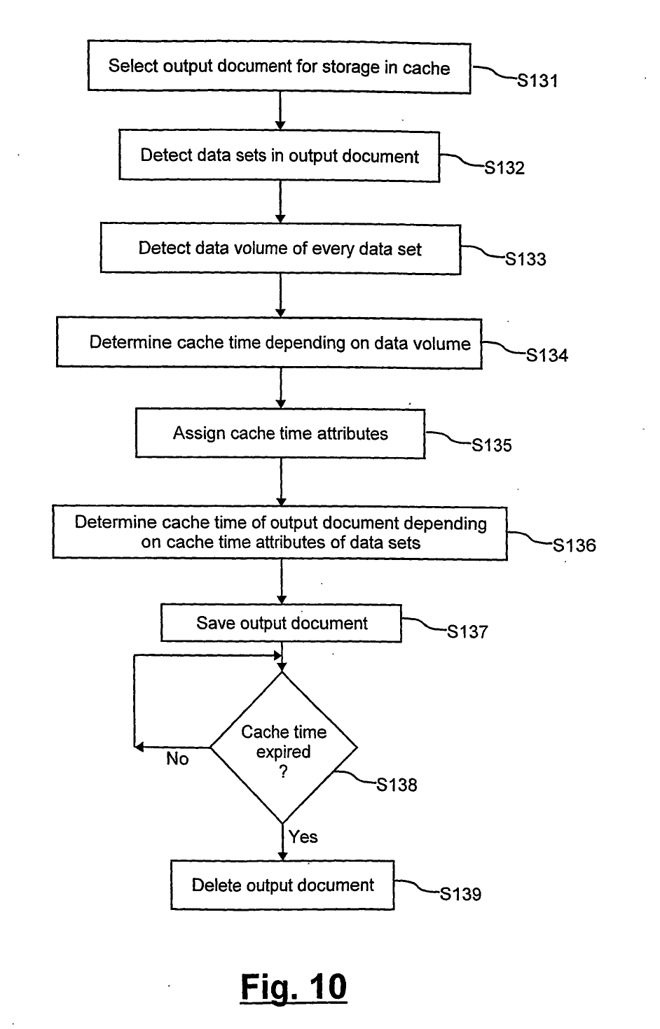

FIG. 10 is a flow chart illustrating method steps of a still further embodiment of the data storage method according to the present invention.

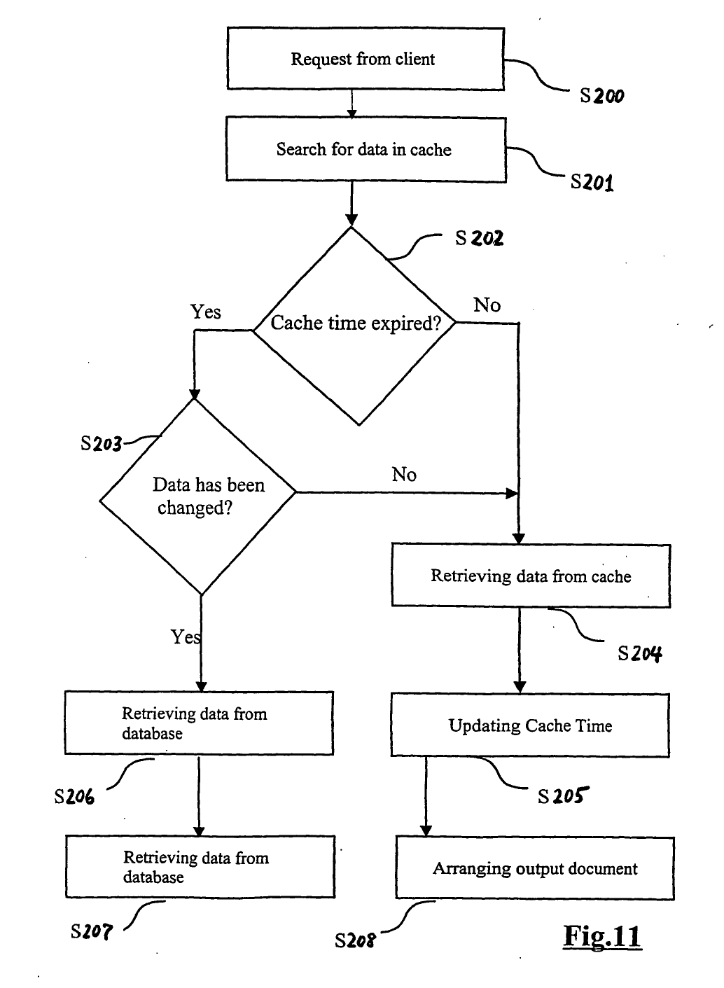

FIG. 11 is a flow chart illustrating method steps of a still further embodiment of the data storage method according to the present invention.

FIG. 1 shows a block diagram of a computer system according to the present invention. A web server 100 is connected through a suitable data transfer medium, e.g. the internet with one or a plurality of clients 102, 105. A client may be embodied by a personal computer, a TV set with internet connection, a mobile phone or the like. The web server 100 may be connectable to a large number of clients.

The web server 100 is connected to an application server 103. In the embodiment illustrated in FIG. 1 the application server 103 consists of 3 separate devices 103a, 103b and 103c. Any desired number of application servers may be provided in order to adapt the computer system to the required data processing capacity. For simplicity's sake, however, in the following FIGS. 2 to 5 only one application server 103 is shown. The web server as well as the application server(s) may be embodied by any suitable computing device containing interface means, processing means, storage means like hard discs, RAM-memories, etc. The application server 103 accesses a data base 104 as well as a cache memory 106. Furthermore, the application server 103 carries out the formatting of data for output to a client. The data base 104 may be embodied by any suitable type of data base or file server, preferably adapted for handling a large data volume. The cache memory (or cache) 106 is preferably designed to provide short data access times.

FIG. 2 schematically illustrates an operation of temporarily storing data sets DS1, DS2 contained in an output document 400 in cache memory 106. A client 102 requests from web server 100 a number of data sets, for example items of an online shopping catalogue. The web server 100 sends the request to the application server 103 which in turn searches and retrieves requested data sets DS1 and DS2 from data base 104. The data sets DS1 and DS2 are then arranged in an output document or template which may be an HTML-page, a XML or WML document or any other suitable output medium. The output document 400 is then transferred to the web server 100 and subsequently to client 102. Simultaneously, the output document 400 containing data sets DS1 and DS2 is temporarily stored in cache memory 106, which is accessible by the web server 100 as well as by the application server 103.

The method steps for performing these operations are schematically illustrated in FIG. 6. In step S1 a request from a client is received by web server 100 and transmitted to application server 103, which in turn proceeds with step S2 retrieving the data sets DS1, DS2 from data base 104. The data are then in step S3 arranged in an output document which is stored in the cache memory (step S4) and also outputted to the client (step S5) by the web server 100.

The data sets contained in output document 400 stored into the cache memory 106 are provided with a cache time attribute, which defines the storage period of every data set in cache memory 106. The storage period of output document 400 may be defined in a suitable way depending on the cache time attributes of the data sets contained therein as will be explained herein below referring to FIGS. 8 to 10.

The operation of retrieving an output document from cache 106 is now explained referring to FIGS. 3 and 6. The same client 102 or another client, here called client 105, requests from web server 100 the data contained in output document 400 (step S11). Web server 100 then checks whether or not the requested data are contained in cache memory 106. If this is the case, output document 400 is retrieved from cache 106 (step S12). This output document is subsequently outputted the client in method step S13.

A variation of the above explained operation will now be explained. Upon a request from a client web server 100 sends the request to the application server 103 which in turn fetches an output document or template which contains an “include” command followed by a URL where the object to be included can be found. The application server requests from the web server this URL and the web server searches in the cache memory 106 under this URL address. If there is an entry in the web server under the URL the content thereof is included in the template for output to the client. If there is no entry in the cache memory 106 the web server 100 transmits the request back to the application server which retrieves the necessary data from the data base and generates the “include” object by carrying out the necessary formatting operations. The “include” object is then transmitted to web server 100 for output to the client. The web server also determines a cache time attribute for the “include” object and stores the same in the cache memory. For the next request the “include” object can be retrieved by the web server directly from the cache memory 106.

The operation of selecting the cache time and assigning the cache time attribute is now explained with reference to FIGS. 8 to 10.

FIG. 8 illustrates a first embodiment of the present invention. In step S101 a data set is selected for storage in the cache memory. Then, according to this embodiment, the cache time is selected manually, i.e. input by the user through suitable input means like a keyboard, a mouse, et cetera. A cache time attribute containing this selected cache time is then assigned to the data set. The cache time attribute may be any information capable of defining a time period. The cache time attribute may define a time in seconds attached to the data set. The cache time may be determined individually for every data set or for specific data set categories. If the cache time is determined for a specific category, the caching time is valid for all data sets which belong to the respective category. The cache time attributes of a plurality of data sets may also be stored in a separate section of the cache memory. The data set may then contain a pointer to the corresponding cache time attribute in this storage section.

A data set may be any suitable arrangement of a data which is handled and forwarded as a data unit. A data set may for example be a catalogue of an online store, price list, et cetera.

The data set is then stored with the cache time attribute in the cache memory (step S104). The data set is held in the cache for the time period defined by the cache time attribute. The data set is held in the cache until the cache time expires (steps S105 and S106).

FIG. 9 illustrates a second embodiment of a method according to the present invention. In this case, the cache time is not determined manually but selected automatically depending on system parameters. In step S111 the data set for storage in the cache memory is selected and, in step S112, a data quantity of the data set is determined. Dependent on this data quantity the method proceeds to step S113 setting the cache time dependent on the data quantity. In most cases it may be advantageous to assign a long cache time to large data sets and a short cache time to small data sets, because a large data set requires more processing work for the application server. In step S114 the cache time attribute is assigned in the same manner as in the method according to the first embodiment. In step S115 the data set with the cache time attribute is stored in the cache memory.

According to this embodiment, however, the cache time attribute is not defined statically but adapted dynamically dependent on system parameters like the access frequency of the data set or the load of the application server. Within the scope of the present invention the skilled person may select any suitable system parameter influencing the cache time. In method step S116 the access frequency of the data set and in method step S117 the application server load is therefore detected. Subsequently, in method step S118 the cache time attribute is adapted dependent on these parameters detected in the previous steps S116 and S117. Preferably the cache time is made longer if a data set is accessed more frequently. Moreover, the cache time may be increased if the load of the application server is large. In addition, the cache time of a data set may also be adapted dependent on the amount of empty storage space in the cache memory.

In step S119 the expiry of the cache time as defined by the cache time attribute is awaited. If the cache time has expired the method proceeds to step S120 in which the data set is deleted from the cache memory.

A further embodiment of the data storage method according to the present invention is illustrated in FIG. 10. In this embodiment the data sets are not stored separately in the cache memory but arranged in an output document, as has been illustrated in FIGS. 2, 3 and 6. In step S131 an output document is selected for storage in the cache. Then, in step S132, the data sets contained in the output document are detected and the data volume of each data set is determined. The cache time of every data set is then determined depending on the data volume. Consequently, to every data set contained in the output document a cache time attribute is assigned.

Then, in step S136, the cache time of the output document is determined dependent on the cache time attributes of the respective data sets. The cache time of the whole document can be equal to the shortest cache time or to the longest cache time of the data sets contained in the document. Alternatively an average value as an arithmetic average or a geometric average may be chosen. Another possibility is to assign priorities to the respective data sets. For example, a large data set or a frequently requested data set may be assigned a higher priority. The cache time of the whole document may then be selected as the cache time of the data set having the highest priority.

In the next step, method step S137, the output document is saved in the cache memory. In step S138 the expiry of the cache time is awaited. If the time has expired the output document is deleted from the cache memory in step S139.

A further mode of operation applying the present invention is now explained with reference to FIGS. 4, 5 and 7. As in the above described case, client 102 requests from web server 100 data, which are retrieved from the data base (steps S21 and S22 in FIG. 7). Before the data, in this example data set DS1 and DS2, are arranged in an output document, the data sets are formatted and in step 23 individually stored in the cache memory by a storage control unit 108 of the application server 103. To every formatted data set a cache time attribute is assigned defining a cache storage period as has been explained above with reference to FIGS. 8 to 10. In method step S24 the data are arranged in an output document which in turn is outputted to the client in method step S25. It is also possible to carry out, as a background task, the storage of the data sets in different formats, e.g. HTML, XML and WML format. This background task is processed with a lower priority when the application server load is low.

Data retrieval from the cache is illustrated in FIG. 5. A client, in this example client 105 requests data including data sets DS1, DS2 and DS4. Whereas formatted data sets DS1 and DS2 are contained in cache memory 106, in the present example data set DS4 is only stored in data base 104. Data sets DS1 and DS2 are consequently retrieved from the cache in method step S32, whereas data set DS4 is fetched from the data base. All data sets are then arranged by the application server 103 in an output document 600 (method step S33), which is subsequently, in step S34, outputted to client 105.

The advantage of the method according to the first processing mode illustrated in FIGS. 2, 3 and 6 is a short information access time, since the complete output document 400 is stored in the cache 106 and maybe accessed directly by web server 100. It is thus not necessary to arrange the data in an output document. The data can therefore be transferred more quickly to the client. The advantage of the second processing mode illustrated in FIGS. 4, 5 and 7 is a higher flexibility. In the shown example data set DS4 of the information requested by the client 105 (FIG. 5) is only stored in the data base. Data set DS4 may be a small data set requiring only a short retrieval time in the data base and/or a data set which is requested only very infrequently by a client. Data sets DS1 and DS2, however, may be large data sets the retrieval time of which from the data base is therefore long. If only complete output documents are stored in the cache, the request from client 105 in the example shown in FIG. 5 had completely to be taken from the data base which would be very time consuming and imposing a lot of processing work to the application server 103. According to the second processing mode of the invention, however, the large and/or frequently requested data sets DS1 and DS2 can be fetched from the cache 106. Since a plurality of clients or users wish to receive different data sets, possibly also in different output formats like HTML, XML or WML (wireless markup language), it is impossible to store the output document for every user in the cache memory. Storing the data sets individually in the cache memory and then arranging the formatted data sets in a suitable output template is thus much more flexible and allows to reduce retrieval times and the load of the application server. With the second mode the individual “time-stamping” of the data sets by the cache time attribute is particularly useful. The cache storage time of every single data set can be selected separately taking into account the data quantity, the access frequency or other parameters. Since the data sets are stored in a formatted or pre-formatted form in the cache memory they can be easily adapted and included into different output templates which saves additional processing load of the application server.

Another embodiment of the invention is shown in FIG. 11.

In this embodiment of the invention the expiration of the cache time does not result in removing/deleting the data sets from the cache. In step S200 the system according to this embodiment receives a client request for data set 1 and 2. In step S201 the system according to the invention searches in the cache for the data set 1 and data set 2. If the system according to the invention finds the data sets in the cache, the system checks in step S202 whether the cache time of a data set has expired. If the cache time of a data set has expired the system checks in step S203 whether the respective data set has been changed.

If the data set has not been changed in the meantime, the system retrieves in step S204 the data set from the cache, although the cache time of the respective data set has expired. At the same time in step S205 the cache time of the data set in the cache that has not been changed will be updated.

If the data sets have changed the system retrieves in step S206 the data sets from the data base and processes in step S207 the respective formatting operations for the data set. Depending on the result of step S203 the system in step S208 arranges the received data sets either from the cache and/or the application server in an output document to send this output document to the client in response to the client request.

The embodiment shown in FIG. 11 has the advantage that data with expired cache time can still be retrieved from the cache as long as enough memory space is available and the data have not been changed. If the data have been changed an update is stored in the cache for future retrieval. The overall efficiency of the system is increased.

1. A data storage method comprising the steps of:
selecting a data set from a data base
assigning the selected data set a cache time attribute defining a cache storage period,
storing the data set in a cache memory for a time period defined by said cache time attribute.

2. The method of claim 1, wherein the cache time attribute is user-defined.

3. The method of claim 1, wherein the cache time attribute is defined by computer system information.

4. The method of claim 3, wherein the cache time is defined dependent on the data volume of the respective data set.

5. The method of claim 3, wherein the cache time is defined dependent on the access frequency of the respective data set in the cache memory.

6. The method of claim 3, wherein the cache time is defined dependent on the load of a computer system.

7. The method of claim 3, wherein the cache time is defined as a fixed value dependent on a data update cycle of the data base.

8. The method of claim 1, wherein the cache time attribute is stored together with the data set in the cache memory.

9. The method of claim 3, wherein a plurality of data set categories are provided to which respective cache time attributes are assigned.

10. The method of claim 1, wherein every data set is stored separately in the cache memory.

11. The method of claim 10, wherein the data set is stored as formatted data set in the cache memory.

12. The method of claim 10, wherein a plurality of data sets are outputted as part of an output document.

13. The method of claim 1, wherein a plurality of data sets are stored in the cache memory as part of an output document.

14. The method of claim 13, wherein the cache time of an output document is determined by the cache time of the data sets contained therein.

15. The method of claim 14, wherein the shortest cache time of anyone of the data sets is selected as the cache time of the output document.

16. The method of claim 14, wherein the longest cache time of anyone of the data sets is selected as the cache time of the output document.

17. The method of claim 14, wherein an average cache time among the data sets is selected as the cache time of the output document.

18. The method of claim 14, wherein different priorities are assigned to different data sets and the cache time of the data set having the highest priority is selected as the cache time of the output document.

19. The method of claim 12, wherein the output document is an HTML, XML or WML document.

20. A load management method of a computer system comprising a web server connectable to a plurality of clients over a data transmission medium, an application server, a data base and a cache memory, comprising the steps of:
selecting from the data base a plurality of data sets,
assigning the selected data sets a respective cache time attribute defining a cache storage period depending on computer system parameters detected by the application server,
storing the selected data sets in the cache memory for a time period defined by said cache time attribute.

21. The method of claim 20, wherein the computer system parameters are selected from the computer system load, the access frequency of a respective data set and/or the data volume of a respective data set.

22. A computer program comprising program code adapted to perform the method steps of:
selecting a data set from a data base
assigning the selected data set a cache time attribute defining a cache storage period,
storing the data set in a cache memory for a time period defined by said cache time attribute.

23. The computer program of claim 22 comprising program code adapted for determining the cache time attribute dependent on computer system information.

24. A computer program product stored on a storage medium comprising program code adapted to perform the method steps of claim 1.

25. A data structure comprising a plurality of individual data sets which is assigned a cache time attribute defining a cache storage period of the respective data set in a cache memory.

26. An application server accessing a data base and a cache memory and being adapted to:
select a data set from the data base,
assign the selected data set a cache time attribute defining a cache storage period,
store the data set in the cache memory for a time period defined by the cache time attribute.

27. A computer system comprising:
a web server connectable to a plurality of clients by means of a data transmission medium,
an application server,
a data base, and
a cache memory,
the application server being adapted to:
select from the data base a plurality of data sets,
assign the selected data sets a respective cache time attribute defining a cache storage period,
the application server and/or the web server being adapted to:
store the data set in the cache memory for a time period defined by the cache time attribute.

28. The computer system of claim 27, wherein the cache time attribute is user-definable.

29. The computer system of claim 27, wherein the web server and/or the application server defines the cache time attribute dependent on computer system information.

30. A computer system of claim 27, wherein the data sets are categorized into a plurality of data set categories, to which respective cache time attributes are assigned.

31. The computer system according to claim 27, wherein the web server accesses the cache memory.

32. The computer system of claim 31, wherein the cache memory stores the data sets as part of an output document.

33. The computer system of claim 32, wherein the cache time of the output document is determined by the cache time of the data sets contained therein.

34. The computer set of claim 27, wherein the application server accesses the cache memory.

35. The computer system of claim 34, wherein every data set is stored separately in the cache memory.

36. The computer system of claim 35, wherein the data sets are stored as formatted data sets in the cache memory.

37. The computer system of claim 27, wherein the cache time attribute is stored together with the data set in the cache memory.

38. The computer system of claim 27, wherein the cache time attributes of a plurality of data sets are stored in a separate section of the cache memory and the data sets contain pointers to the correponding cache time attributes.

39. A data storage method comprising the steps of:
selecting a data set from the database,
assigning the selected data set a cache time attribute defining a cache storage period,
storing the data set in a cache memory for at least time period defined by said cache time attribute,
if the data set is accessed in the cache memory after expiration of the defined cache time, checking whether the data set stored in the cache memory is identical with the corresponding data set in the database and if the data sets are identical, retrieving the data set from the cache memory and resetting the cache time attribute, and if the data sets are not identical, retrieving the data set from the database, updating the data set in the cache memory and resetting the cache time attribute.

40. The method of claim 39, wherein the data set accessed in the cache memory is outputted as part of an output document.

41. A computer system comprising:
a web server connectable to a plurality of clients by means of a data transmission medium,
an application server,
a database, and
a cache memory,
the application server being adapted to:
select from the database a plurality of data sets,
assign the selected data sets a respective cache time attribute defining a cache storage period,
the application server and/or the web server being adapted to:
selecting a data set from a database,
assigning the selected data set a cache time attribute defining a cache storage period,
storing the data set in a cache memory for at least a time period defined by said cache time attribute
if the data set is accessed in the cache memory after expiration of the defined cache time, checking whether the data set stored in the cache memory is identical with the corresponding data set in the database, and if the data sets are identical, retrieving the data set from the cache memory and resetting the cache time attribute, and if the data sets are not identical, retrieving the data set from the database, updating the data set in the cache memory and resetting the cache time attribute.

42. The method of claim 4, wherein the cache time is defined dependent on the access frequency of the respective data set in the cache memory.

43. The method of claim 11, wherein a plurality of data sets are outputted as part of an output document.
